(19) United States
(12) Patent Application Publication
(10) Pub. No.: US 2012/0057252 A1
(43) Pub. Date: Mar. 8, 2012

(54) CAPACITIVE TYPE HUMIDITY SENSOR AND MANUFACTURING METHOD THEREOF

(76) Inventors: Katsuyuki Ishiguro, Miyagi-ken (JP); Takuya Kato, Miyagi-ken (JP); Yoshinori Fujitani, Miyagi-ken (JP)

(21) Appl. No.: 13/227,120

(22) Filed: Sep. 7, 2011

(30) Foreign Application Priority Data
Sep. 7, 2010 (JP) 2010-199804

(51) Int. Cl. G02B 7/02

(52) U.S. Cl. 359/824

(57) ABSTRACT

A lens drive apparatus includes a lens holder configured to hold a lens body, a translating mechanism having a magnet, a coil, and a yoke and configured to translate the lens holder along the direction of an optical axis, and a base member formed of a resin material and including an insert-molded metal plate member in a state of being partly exposed, in which the part of the metal plate member exposed from the base member has a structure thicker than other parts, and part of the yoke is fixed to the metal plate member exposed from the base member.

### CLAIM OF PRIORITY

This application claims the benefit of Japanese Patent Application No. 2010-199804 filed on Sep. 7, 2010, which is hereby incorporated by reference in its entirety.

### BACKGROUND

1. Field of the Disclosure

The present disclosure relates to a lens drive apparatus and, more specifically, to a lens drive apparatus preferable for an automatic focusing mechanism or the like in a digital camera.

2. Description of the Related Art

In the related art, as one of lens drive apparatuses used for automatic focusing mechanisms or the like in digital cameras, a configuration in which a lens holder configured to hold a lens body is translated along the direction of an optical axis by a translating mechanism including a magnet, a coil, and a yoke is known (For example, see Japanese Unexamined Patent Application Publication No. 2008-52196). In this lens drive apparatus, the yoke, which constitutes the translating mechanism, is fixed to an inner wall of a shield case, which constitutes an outer wall of the apparatus, and the shield case is fixedly adhered to a resin-made base member, which constitutes a bottom surface of the apparatus.

However, in the lens drive apparatus described above, since the shield case having the yoke fixed thereto is fixedly adhered to the resin-made base member which is difficult to control the flatness on the order of several hundred microns, there is a problem in that it is difficult to set the position of the lens member held by lens holding means with high precision. Although fixing of the yoke by laser welding is also contemplated, it may result in adverse effect on the resin-made base member.

In view of such circumstances, the invention provides a lens drive apparatus which allows setting of the position of a lens body held by lens holding means with high precision and has a structure suitable for using laser welding for fixing a yoke.

### SUMMARY

A lens drive apparatus includes lens holding means configured to hold a lens body, a translating mechanism having a magnet, a coil, and a yoke and configured to translate the lens holding means along the direction of an optical axis, and a base member formed of a resin material and including an insert-molded metal plate member in a state of being partly exposed, in which the part of the metal plate member exposed from the base member has a structure thicker than other parts, and part of the yoke is fixed to the metal plate member exposed from the base member.

According to the lens drive apparatus described above, since part of the yoke is fixed to the metal plate member exposed from the base member, the flatness of a reference plane that allows the yoke to be fixed thereto can be secured in comparison with the lens drive apparatus in the related art in which the positioning of the yoke is performed with respect to the resin-made portion of the base member. Therefore, the position of the lens body to be held by the lens holding means can be set with high precision. Also, since the metal plate member exposed from the base portion which allows part of the yoke to be fixed thereto has a structure thicker than other portions, the adverse effect such that the laser used for welding penetrates through the metal plate member and hence burns the resin material of the base member can be restrained. Therefore, a structure suitable for using laser welding for fixing the yoke is achieved.

In the lens drive apparatus described above, it is preferable that the part of the metal plate member exposed from the base member has a laminated structure made up of a plurality of the metal plate members. In this case, since the metal plate member exposed from the base portion which allows the part of the yoke to be fixed thereto has the structure made up of the plurality of metal plate members, the adverse effect such that the laser used for welding penetrates through the metal plate member and hence burns the resin material of the base member can be restrained, so that a structure suitable for using the laser welding for fixing the yoke is achieved.

In the lens drive apparatus described above, it is preferable that the part of the metal plate member exposed from the base member has the laminated structure by being folded. In this case, since the metal plate member exposed from the base portion which allows part of the yoke to be fixed thereto has a laminated structure by being folded, the adverse effect such that the laser used for welding penetrates through the metal plate member and hence burns the resin material of the base member can be restrained, so that the structure suitable for using the laser welding for fixing the yoke is achieved. Since only the part of the metallic material exposed from the base portion which allows the part of the yoke to be fixed thereto is formed into the laminated structure, the thickness of the entire metal plate member does not change, and the thickness of the entire lens drive apparatus is not affected. In the lens drive apparatus, since power feeding terminals or a positioning shape depend on the layout of a substrate on the side of an image pickup device, the points of welding also change. Therefore, with the structure as described above, flexibility of weldable points can be enhanced.

In the lens drive apparatus described above, it is preferable that the yoke is fixed to the metal plate member exposed from the base member by welding. In this case, since the metallic member exposed from the base member and the yoke are fixed by welding, in comparison with the lens drive apparatus in the related art configured to fix a shield case having the yoke fixed thereto with respect to the base member by adhesion, time required for fixing the yoke can be reduced, and time required for manufacturing the lens drive apparatus can be reduced.

In the lens drive apparatus described above, it is preferable that the base member has a rectangular shape and part of the metal plate member is exposed in part of side surface portions and an upper surface portion of the base member. In this case, since the yoke is fixed to the metallic member exposed from the parts of the side surface portions and the upper surface portion of the base member formed into the rectangular shape, increase in the size of the apparatus body can be prevented.

In the lens drive apparatus as described above, the metal plate member includes a grounding strip and the yoke is grounded via the metal plate member. In this case, since the yoke can be grounded via the metallic plate member insert-molded with the base member, it is not necessary to provide a configuration for grounding the yoke separately, and hence the structure of the entire apparatus body can be simplified.

In the lens drive apparatus described above, it is preferable that the metal plate member is formed of a material superior in solder wettability. In this case, the satisfactory joint state between the metallic member and the yoke can be secured, so that the yoke can reliably be fixed to the base member.

### BRIEF DESCRIPTION OF THE DRAWINGS

FIG. 1 is an exploded perspective view of a lens drive apparatus according to an embodiment of the invention;

FIG. 2 is a perspective view of a base member provided in the lens drive apparatus according to the embodiment;

FIG. 3 is a perspective view of the lens drive apparatus according to the embodiment; and

FIG. 4 is a side view of the lens drive apparatus according to the embodiment.

### DESCRIPTION OF THE EXEMPLARY EMBODIMENTS

Referring now to the attached drawings, an embodiment of the invention will be described in detail.

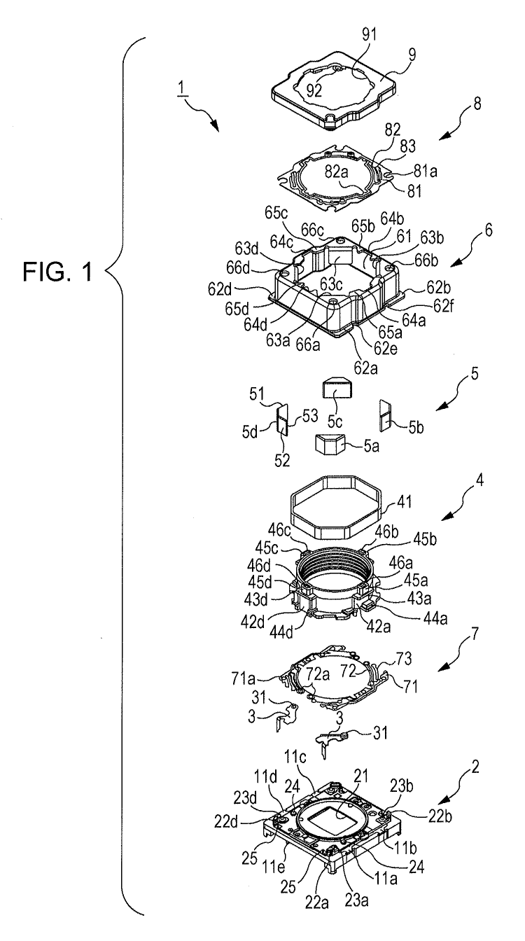

FIG. 1 is an exploded perspective view of a lens drive apparatus 1 according to an embodiment of the invention. The lens drive apparatus 1 includes a base member 2 constituting a bottom surface portion of the apparatus, a pair of terminals 3, a lens holder 4 as lens holding means configured to hold a lens body (not shown), a magnet 5 and a yoke 6 constituting a translating mechanism which causes the lens holder 4 to translate in the direction of an optical axis, a pair of leaf springs (lower leaf spring 7 and upper leaf spring 8) configured to resiliently fix the lens holder 4 to the base member 2 and the yoke 6, and a cover member 9 configured to fix the upper leaf spring 8 to the yoke 6.

The base member 2 is formed of an insulative resin material, for example, and is formed to have a rectangular shape. Provided in the vicinity of the center of the base member 2 at a position corresponding to an image sensor (not shown), is a rectangular opening 21. Also provided at four corners of the base member 2, are fitting strips 22a to 22d (22c is not shown in FIG. 1) configured to fit to an inner wall of the yoke 6. Provided in the vicinity of the fitting strips 22a to 22d, are positioning strips 23a to 23d (23c is not shown in FIG. 1) configured to position the yoke 6 and the lower leaf spring 7.

A metal plate member 11 having a predetermined shape is formed on the base member 2 by insert molding in a partly exposed state. The metal plate member 11 includes hooking portions 11a to lid exposed on side surface portions on opposed two sides and an upper surface portion of the base member 2, and a grounding strip lie extending so as to be bent downward in the vicinity of the hooking portion 11d. The metal plate member 11 is formed of a metallic material superior in solder wettability such as white metal, phosphor bronze, or stainless nickel-plated as a base and then gold-plated. The metal plate member 11 functions as an external terminal with respect to a substrate or the like on which the lens drive apparatus 1 is mounted.

The pair of terminals 3 are each positioned and fixed by a fitting hole 31 fitted on a fixing pin 24 formed on the base member 2. The pair of terminals 3 each extends downward by being bent from locking grooves 25 formed on the base member 2. Among the sides of the base member 2, the side where the terminals 3 extend from and the side where the grounding strip lie extends from are the same.

The lens holder 4 is formed of an insulative resin material, for example, and is generally formed to have a cylindrical shape. Provided on an inner periphery of the lens holder 4, is a screw groove which allows the lens body (not shown) to be screwed in. Provided on an outer periphery of the lens holder 4 are four holding strips 42a to 42d (42b and 42c are not shown in FIG. 1) configured to hold a coil 41. Provided at upper ends and lower ends of the holding strips 42a to 42d are positioning strips 43a to 43d (upper end) and positioning strips 44a to 44d (lower end) (43b, 43c, 44b, and 44c are not shown in FIG. 1) configured to restrict the movement of the coil 41 and position the coil 41. Provided above the positioning strips 43a to 43d are projecting strips 45a to 45d projecting radially outward from an outer peripheral surface of the lens holder 4. Provided further on upper ends of the projecting strips 45a to 45d are positioning strips 46a to 46d configured respectively to position the upper leaf spring 8. The positioning strips 46a to 46d are configured to be engageable with notches 82a of the upper leaf spring 8, described later.

The magnet 5 includes four magnets 5a to 5d to be fixed at four corner portions of the yoke 6. The magnets 5a to 5d respectively include a pair of side surface portions 51 and 52 orthogonal to each other and an inner peripheral surface portion 53. In this case, the magnets 5a to 5d are fixed in a state in which the side surface portions 51 and 52 face inner wall surfaces of the yoke 6 at four corners thereof and the inner peripheral surface portion 53 faces inner wall surfaces of hanging wall surfaces 63a to 63d of the yoke 6, described later, at a certain distance away therefrom. For example, the magnets 5a to 5d are fixed at the four corner portions of the yoke 6 by adhesion of the side surface portions 51 and 52 thereto with an adhesive agent or the like.

The coil 41 is bundled generally into an octagonal ring shape, and an inner peripheral portion thereof is held by the holding strips 42a to 42d of the lens holder 4, described above. The coil 41 is arranged at a certain distance away from the outer peripheral surface of the lens holder 4 at portions where the holding strips 42a to 42d are not present by the holding strips 42a to 42d formed so as to project slightly in the radial direction with respect to the outer peripheral surface of the lens holder 4. In this manner, the outer peripheral surface of the coil 41 held on the lens holder 4 is arranged so as to face the inner peripheral surface portion 53 of the magnets 5a to 5d, while the inner peripheral surface of the coil 41 are arranged so as to face the inner wall surfaces of the hanging wall surfaces 63a to 63d of the yoke 6. In the lens drive apparatus 1, since the coil 41 is formed so as to have generally the octagonal ring shape in this manner, a larger opening at the center can be secured in comparison with a case where the coil 41 is formed into a circular ring shape, so that a larger space can be secured for mounting the lens to be held by the lens holder 4.

The yoke 6 is formed by machining a metallic material and has a box shape opening downward as shown in FIG. 1. The yoke 6 is formed generally in a rectangular shape having an opening 61 generally in an octagon shape at the center thereof. The yoke 6 is provided at lower end portions on two opposing sides thereof with fixed strips 62a to 62d (62c, 62g, and 62h are not shown in FIG. 1) projecting slightly sideward and having notches 62e to 62h in part thereof. The notches 62e to 62h formed on the fixed strips 62a to 62d are provided corresponding to the hooking portions 11a to lid of the base member 2. Provided also on a peripheral edge portion of the opening 61 at positions corresponding to the four corners of the yoke 6 are the hanging wall surfaces 63a to 63d hanging downward. The hanging wall surfaces 63a to 63d are arranged between the outer peripheral surface of the lens holder 4 and an inner peripheral surface of the coil 41 in a state in which the lens holder 4 is accommodated. In addition, provided on the peripheral edge portion of the opening 61 at positions between the hanging wall surfaces 63a to 63d are four depressions 64a to 64d which can accommodate the projecting strips 45a to 45d of the lens holder 4. Provided also laterally of the depressions 64a to 64d are pairs of abutting strips 65a to 65d each projecting slightly inward of the opening 61. In addition, the yoke 6 are formed with four holes 66a to 66d which allow insertion of fixing pins 92 of the cover member 9, described later, on the upper surface at positions in the vicinity of the four corner portions.

The lower leaf spring 7 is formed of a conductive material such as phosphor bronze, and includes a pair of outer fixed portions 71 to be fixed to the base member 2, a pair of inner fixed portions 72 to be fixed to a lower surface of the lens holder 4, and four arm portions 73 configured to connect the outer fixed portions 71 and the inner fixed portions 72. The outer fixed portions 71 are formed with a plurality of holes 71a at predetermined positions, and the lower leaf spring 7 is fixed to the base member 2 in a state in which the positioning strips 23a to 23d of the base member 2 are inserted into the holes 71a. Also, the inner fixed portions 72 are formed with a plurality of holes 72a at predetermined positions, and the lower leaf spring 7 is fixed to the lens holder 4 in a state in which the fixing pins provided on the lower surface of the lens holder 4 are inserted into the holes 72a. The arm portions 73 extend so as to be folded back and forth a plurality of times from the positions of the outer fixed portions 71 corresponding to the four corner portions of the base member 2 and are connected to the inner fixed portions 72.

The upper leaf spring 8 is formed of a conductive material such as phosphor bronze in the same manner as the lower leaf spring 7, and includes a ring-shaped outer fixed portion 81 to be fixed to an upper surface of the yoke 6, a ring-shaped inner fixed portion 82 to be fixed to an upper surface of the lens holder 4, and four arm portions 83 configured to connect the outer fixed portion 81 and the inner fixed portion 82. The outer fixed portion 81 is formed with four holes 81a at predetermined positions, and the upper leaf spring 8 is fixed to the yoke 6 in a state in which the fixing pins 92 of the cover member 9, described later, are inserted into the holes 81a. Also, the inner fixed portion 82 is formed with the four notches 82a at predetermined positions, and the upper leaf spring 8 is fixed to the lens holder 4 in a state in which the positioning strips 43a to 43d of the lens holder 4 are accommodated in the notches 82a. The arm portions 83 extend so as to be folded back and forth a plurality of times from the positions on the outer fixed portion 81 corresponding to the four corner portions of the yoke 6 and are connected to the inner fixed portion 82.

The cover member 9 is formed by machining a metallic material. The cover member 9 is formed generally in a rectangular shape having an opening 91 in a circular shape at the center thereof. The cover member 9 has substantially the same shape as the shape of the upper surface of the yoke 6, and the opening 91 is formed so as to correspond to the opening 61 of the yoke 6. Provided on a lower surface of the cover member 9 at positions corresponding to the four corner portions thereof are four of the fixing pins 92 configured to fix the upper leaf spring 8 to the upper surface of the yoke 6.

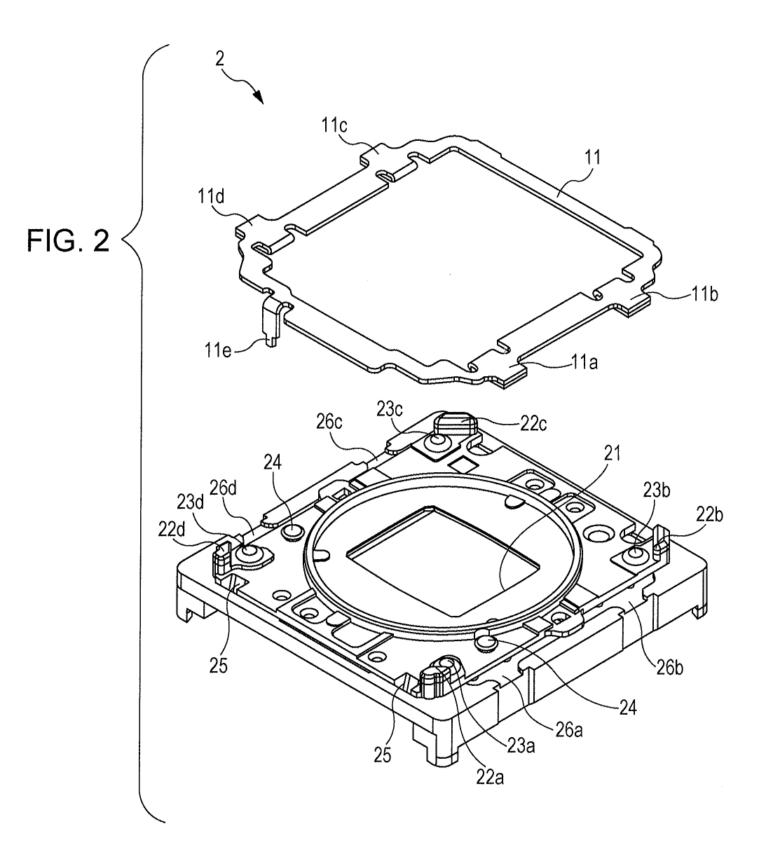

A configuration of the metal plate member 11 insert-molded with the base member 2 of the lens drive apparatus 1 according to the embodiment will now be described. FIG. 2 is a perspective view of the base member 2 provided in the lens drive apparatus 1 according to the embodiment. In FIG. 2, the metal plate member 11 to be insert-molded with the base member 2 is extracted for the sake of convenience of description.

The metal plate member 11 is formed generally into a rectangular shape having a rectangular-shaped opening at the center thereof in plan view. The metal plate member 11 is provided with the hooking portions 11a to 11d respectively in the vicinity of both ends of opposed two sides thereof. The hooking portions 11a to 11d are configured to be fitted into hooking grooves 26a to 26d provided in the vicinity of the positioning strips 23a to 23d of the base member 2 in a state of being insert-molded. Provided in the vicinity of the hooking portion 11d is the grounding strip lie. The grounding strip lie is arranged between two of the locking grooves 25 on the base member 2 and is bent so as to extend downward.

The hooking portions 11a to 11d of the metal plate member 11 each have a structure in which an end portion of the metallic material is folded downward, and this part has a duplicated laminated structure formed by folding the metallic material.

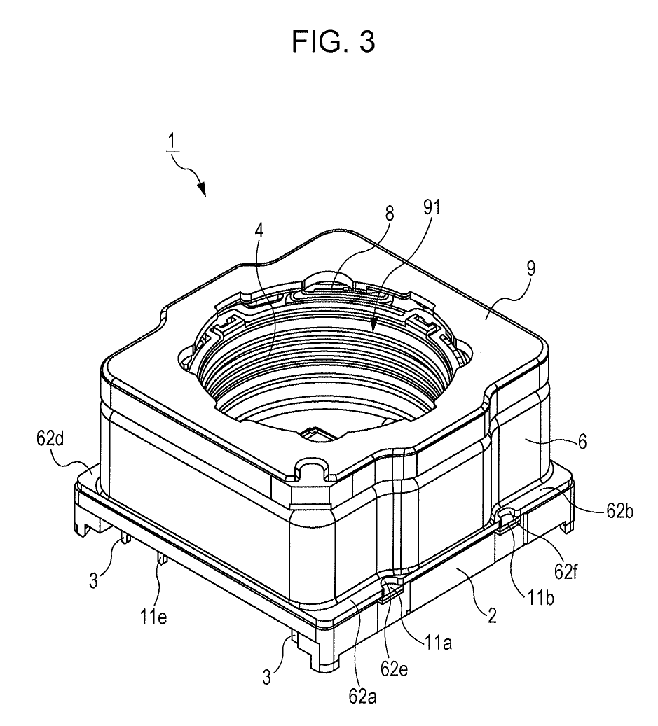

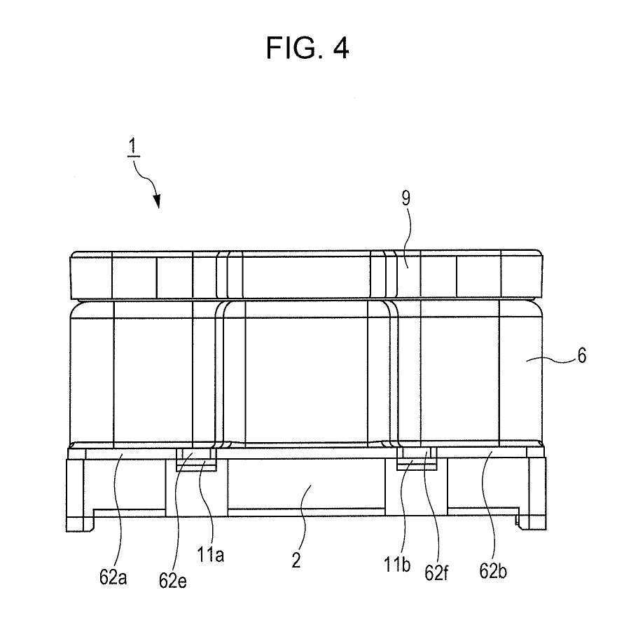

When assembling the lens drive apparatus 1 having such a structure, the lens holder 4 in a state of holding the coil 41 is firstly fixed to the base member 2 via the terminals 3 and the lower leaf spring 7. Subsequently, the yoke 6 having the magnets 5a to 5d fixed to the inner wall at the four corner portions is fixed to the base member 2 so that the lens holder 4 is arranged inside the opening 61 of the yoke 6. Then, the upper leaf spring 8 is placed on the upper surfaces of the lens holder 4 and the yoke 6 so as to accommodate the positioning strips 43a to 43d of the lens holder 4 in the notches 82a of the upper leaf spring 8. Then, the fixing pins 92 of the cover member 9 are inserted into the holes 66a to 66d of the yoke 6 via the holes 81a of the upper leaf spring 8 to fix the cover member 9. Accordingly, the assembly operation of the lens drive apparatus 1 is finished, and the lens drive apparatus 1 in a state shown in FIG. 3 and FIG. 4 is completed.

The yoke 6 is fixed to the base member 2 by covering the fitting strips 22a to 22d of the base member 2 on the base member 2 so as to fit to the inner wall of the yoke 6 at the four corner portions respectively. At this time, as shown in FIG. 3 and FIG. 4, the notches 62e to 62h of the fixed strips 62a to 62d of the yoke 6 assume a state being arranged on the hooking portions 11a to 11d of the metal plate member 11 exposed from the side surface portions and the upper surface portion of the base member 2. Then, by joining the fixed strips 62a to 62d of the yoke 6 and the hooking portions 11a to 11d of the metal plate member 11 by laser welding, the yoke 6 is fixed to the base member 2. In this case, since the metal plate member 11 is formed of the metallic material superior in solder wettability as described above, a satisfactory joint state between the metal plate member 11 and the yoke 6 can be secured. Therefore, the yoke 6 can be reliably fixed to the base member 2.

In the lens drive apparatus 1 according to the embodiment in this manner, parts of the metal plate member 11 insert-molded with the base member 2 are exposed and parts of the yoke 6 are joined to the exposed parts by welding, so that the flatness of a reference plane where the yoke 6 is fixed can be secured in comparison with the lens drive apparatus in the related art in which the positioning of the yoke is performed with respect to the resin-made portion of the base member. Accordingly, the position of the lens body to be held by the lens holder 4 can be set with high precision. Also, in comparison with the lens drive apparatus in the related art configured to fix a shield case having the yoke fixed thereto with respect to the base member by adhesion, time required for fixing the yoke 6 can be reduced, and time required for manufacturing the lens drive apparatus 1 can be reduced.

Since the hooking portions 11a to 11d of the metal plate member 11 are made up of a duplicated metallic material, adverse effect such that the laser used for welding penetrates through the metal plate member 11 and hence burns the resin material of the base member 2 located under the hooking portions 11a to 11d may be restrained. Since only the hooking portions 11a to 11d of the metal plate member 11 are made up of partly the duplicated metallic material, the thickness of the entire metal plate member 11 does not change, and the thickness of the entire lens drive apparatus 1 is not affected. In the lens drive apparatus 1, since power feeding terminals or a positioning shape depend on the layout of the substrate on the side of an image pickup device, the points of welding also change. Therefore, with the structure of the hooking portions as described above, flexibility of weldable points can be enhanced.

Also, since the hooking portions 11a to 11d of the metal plate member 11 are exposed in part on the side surface portions and the upper surface portion of the base member 2 and the fixed strips 62a to 62d of the yoke 6 are fixed to the hooking portions 11a to 11d, increase in the size of the apparatus body can be prevented.

As shown in FIG. 3, the lens holder 4 is arranged in the interior of the opening 91 of the cover member 9 in a state in which the lens drive apparatus 1 is assembled. The lens holder 4 is fixed to the base member 2 via the lower leaf spring 7 while being fixed to the yoke 6 via the upper leaf spring 8, so that the lens holder 4 keeps a state of being held at an initial position by an urging force of the pair of leaf springs. The lens body, not shown, is assembled to the lens holder 4 by being screwed from above shown in FIG. 3, and is configured to be translatable integrally with the lens holder 4.

When an electric current is distributed to the coil 41 held on the outer peripheral surface of the lens holder 4, the electric current passing through the coil 41 acts on a magnetic field generated by the magnets 5a to 5d, so that thrust to move the coil 41 in the vertical direction in FIG. 3 is generated. In the lens drive apparatus 1 according to the embodiment, the thrust is controlled by controlling the amount of current passing through the coil 41 according to a drive instruction from a control unit in a cellular phone or a digital camera in which the apparatus body is mounted, for example, whereby the coil 41 is moved upward and downward to achieve the positioning. Accordingly, the positioning of the lens holder 4 configured to hold the coil 41 is achieved, and the positioning of the lens body assembled in the lens holder 4 is achieved.

In the lens drive apparatus 1 according to the embodiment, the assembly operation of the lens body with respect to the lens holder 4 is performed in a state in which the plurality of projecting strips 45a to 45d provided on the outer peripheral surface of the lens holder 4 are engaged with the abutting strips 65a to 65d provided on the peripheral edge portion of the opening 61 of the yoke 6 to restrict the rotation of the lens holder 4. By causing the projecting strips 45a to 45d of the lens holder 4 to be engaged with the abutting strips 65a to 65d of the yoke 6 as described above, the lens body can be assembled to the lens holder 4 easily without necessity of a specific jig or the like.

In the lens drive apparatus 1 according to the embodiment in this manner, since part of the yoke 6 is fixed to the metal plate member 11 exposed from the base member 2, in comparison with the lens drive apparatus in the related art in which the positioning of the yoke is performed with respect to the resin-made portion of the base member, the position of the lens body to be held by the lens holder 4 can be set with high precision. Also, since the metal plate member 11 exposed from the base portion 2 to which part of the yoke 6 is fixed has a structure thicker than other portions, the adverse effect such that the laser used for welding penetrates through the metal plate member 11 and hence burns the resin material of the base member 2 can be restrained, so that a structure suitable for using laser welding for fixing the yoke 6 is achieved.

The invention is not limited to the embodiment described above, and various modifications may be made for implementation. In the embodiment described above, the size or the shape illustrated in the attached drawings are not limited, and may be changed as needed within a range which achieves the advantages of the invention. Other portions may be modified for implementation as needed without departing the scope of the invention.

For example, although the case in which the part of a housing of the lens drive apparatus 1 is formed of the yoke 6 is described in the embodiment described above, the configuration of the housing is not limited thereto, and modifications may be made as needed. For example, a case may be provided as a housing that is separate from the yoke 6. In this case, it is also possible to transfer the function to restrict the rotation of the lens holder 4, which is now assumed by the yoke 6 to the case.

Although the case in which the hooking portions 11a to 11d of the metal plate member 11 has a structure such that the end portions of the metallic material are folded downward and these parts have the duplicated laminated structure formed by folding the metallic material has been described, the structure of the hooking portions 11a to 11d is not limited thereto, and modifications may be made as needed. For example, the hooking portions 11a to 11d may be formed to have a structure thicker than other portions of the metallic plate member. Possibly, the hooking portions 11a to lid may be formed to have a structure having a plurality of laminated metallic plate members. Alternatively, the hooking portions 11a to lid may be formed into a three-ply or four-ply laminated structure by folding the end portions of the metallic material.

What is claimed is:

1. A lens drive apparatus comprising:
lens holder configured to hold a lens body;
a translating mechanism having a magnet, a coil, and a yoke and configured to translate the lens holder along the direction of an optical axis; and
a base member formed of a resin material, the base member including an insert-molded metal plate member in a partly exposed state,
wherein the part of the metal plate member exposed from the base member has a structure thicker than other parts of the metal plate member, and
part of the yoke is fixed to the metal plate member exposed from the base member.

2. The lens drive apparatus according to claim 1, wherein the part of the metal plate member exposed from the base member comprises a laminated structure of a plurality of the metal plate members.

3. The lens drive apparatus according to claim 2, wherein the part of the metal plate member exposed from the base member comprises a laminated structure by being folded.

4. The lens drive apparatus according to claim 1, wherein the yoke is fixed to the metal plate member exposed from the base member by a weld.

5. The lens drive apparatus according to claim 4, wherein the weld is a laser weld.

6. The lens drive apparatus according to claim 4, wherein the base member comprises a rectangular shape and part of the metal plate member is exposed in part of side surface portions and an upper surface portion of the base member.

7. The lens drive apparatus according to claim 4, wherein the metal plate member includes a grounding strip and the yoke is grounded via the metal plate member.

8. The lens drive apparatus according to claim 5, wherein the metal plate member is formed of a material superior in solder wettability.
